(19) United States
(12) Patent Application Publication
(10) Pub. No.: US 2012/0129506 A1
(43) Pub. Date: May 24, 2012

(54) DESKTOP TO MOBILE DATA AND ACTION TRANSFER

(75) Inventors: Amit Kumar, Redmond, WA (US); Stefan David Weitz, Seattle, WA (US)

(73) Assignee: MICROSOFT CORPORATION, REDMOND, WA (US)

(21) Appl. No.: 12/951,635

(22) Filed: Nov. 22, 2010

(51) Int. Cl. H04W 4/00; H04W 88/02; G06F 17/30

(52) U.S. Cl. 455/414.3; 707/769; 455/566; 707/E17.014

(57) ABSTRACT

Methods and systems for utilizing tags to transfer data are provided. Digital tags may be presented on a display device of a first computing device such that the tags are selectable by a second computing device. The tags may include tag content that is associated with a target item indicated by a user. The tag content may be identified based on actions performed by the second computing device. Upon selection of the tag by the second computing device, the tag content is communicated to the second computing device.

### BACKGROUND

Users are often presented with the inconvenience of accessing information on one computing device that would be useful on a second computing device. The accessed information may be more useful on the second computing device, more convenient, or the like. For example, a user may perform a search for directions to a local restaurant on a desktop computer. The directions may be more useful if they were transferred to a second computing device such as, for example, the user's mobile phone. Currently, there is no way to seamlessly transfer the accessed information from one computing device to a second computing device. Instead, users typically turn to another method such as repeating the steps on the second computing device that were previously completed on the first computing device to access the information, printing the accessed information, emailing the accessed information to a destination accessible on a second computing device, or the like. All of these alternate methods are less efficient and require greater time to accomplish than would a seamless transfer of the data to the second computing device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, utilizing tags to transfer data. A tag, as used herein, refers generally to a digital image having tag content embedded therein. Tag content, as used herein, refers generally to content that has been identified as relevant and/or useful to a tag. Tags may be generated for presentation on a display device of a first computing device. In embodiments, tag content may include information relevant to actions performed by a second computing device. The tags may be generated such that, upon selection thereof by the second computing device, the tag content may be communicated to the second computing device. Accordingly, the actual content is transferred from the tag displayed on the display device of the computing device to the second computing device.

### BRIEF DESCRIPTION OF THE DRAWINGS

The present invention is illustrated by way of example and not limited in the accompanying figures in which like reference numerals indicate similar elements and in which:

FIG. 1 is a block diagram of an exemplary computing system environment suitable for use in implementing embodiments of the present invention;

FIG. 2 is a block diagram of an exemplary computing system in which embodiments of the invention may be employed;

FIG. 3 is a first exemplary user interface illustrating a tag associated with a target item, in accordance with an embodiment of the present invention;

FIG. 4 is a second exemplary user interface upon receiving tag content, in accordance with embodiments of the present invention;

FIG. 5 is a flow diagram showing a first exemplary method 500 for utilizing tags to transfer data, in accordance with an embodiment of the present invention; and

FIG. 6 is a flow diagram showing a second exemplary method 600 for utilizing tags to transfer data, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, utilizing tags to transfer data. Tags may be generated for presentation on a display device of a first computing device. The tags may include tag content, which is content identified as desirable to communicate to a second computing device. The tag content may include information relevant to actions to be performed by the second computing device. The tags are generated such that, upon selection by the second computing device, the tag content is communicated to the second computing device. Accordingly, the actual content is transferred from the tag displayed on the display device of the computing device to the second computing device.

Accordingly, one embodiment of the present invention is directed to one or more computer-readable storage media storing computer-useable instructions that, when used by one or more computing devices, cause the one or more computing devices to perform a method for utilizing tags to transfer data. The method comprises receiving a user input indicating at least one target item on a first computing device. Tag content associated with the at least one target item is then identified. The tag content may be content identified as desirable to transfer to a second computing device. The tag, including the tag content, is associated with the at least one target item. The tag is then presented in association with the at least one target item such that selection of the tag by a second computing device triggers the tag content to be communicated to the second computing device.

Another embodiment of the present invention is directed to a tag generating system. The system comprises a computing device and a data store. The system further comprises a tagging engine that receives an indication of a target item, identifies tag content associated with the target item, and presents the tag in association with the target item on a display device of the computing device.

In yet another embodiment, the present invention is directed to one or more computer-readable storage media storing computer-useable instructions that, when used by one or more computing devices, cause the one or more computing devices to perform a method for utilizing tags to transfer data. The method comprises receiving a search query input at a first computing device and displaying a plurality of search results in response to receiving the search query input. A user selection of at least one search result is received and tag content associated with the at least one search result is identified. The tag is associated with the at least one search result such that the tag is configured for selection by a mobile phone. The tag is presented on a display device of the computing device is association with the at least one search result. Selection of the tag by the mobile phone triggers communication of the tag content from the computing device to the mobile phone.

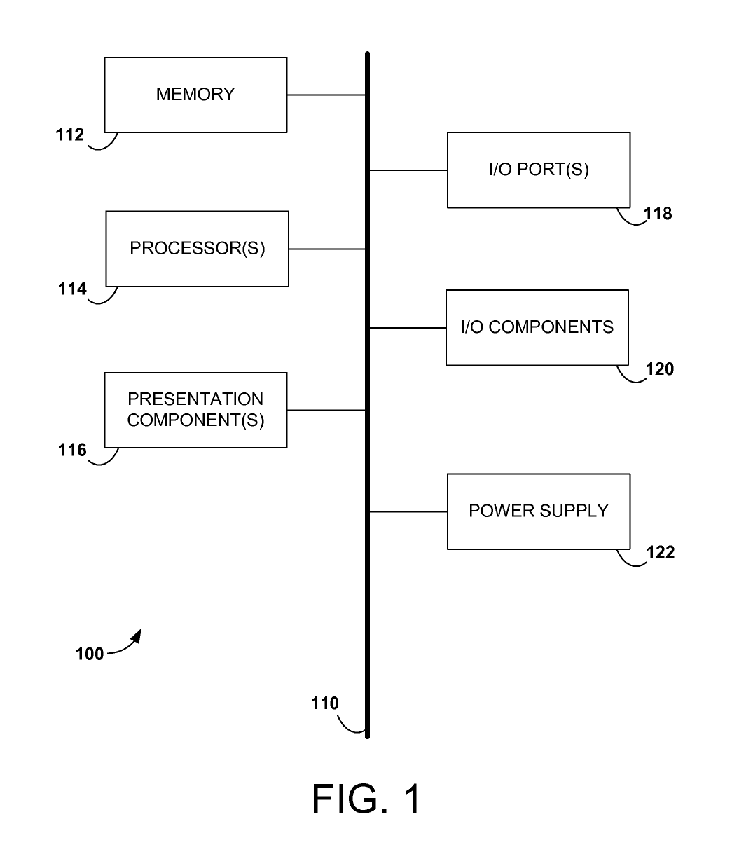

Having briefly described an overview of embodiments of the present invention, an exemplary operating environment in which embodiments of the present invention may be implemented is described below in order to provide a general context for various aspects of the present invention. Referring initially to FIG. 1 in particular, a block diagram illustrating an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” and the like, as all are contemplated within the scope of FIG. 1 and reference to “computing device.”

The computing device 100 typically includes a variety of computer-readable media. Computer-readable media can be any available media capable of being accessed by the computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O component(s) 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O component(s) 120, some of which may be built in. Illustrative components include a microphone, joystick, game pad, satellite dish, scanner, printer, wireless device, and the like.

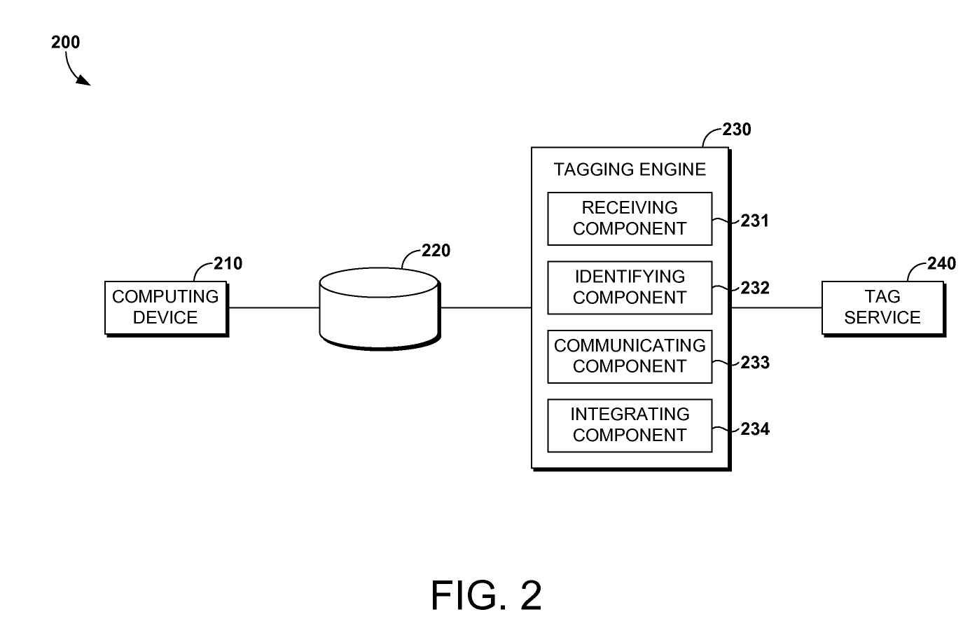

As indicated previously, embodiments of the present invention are directed to utilizing tags to transfer data. In embodiments, tags are utilized to transfer data between two computing devices. Turning now to FIG. 2, a block diagram is provided illustrating an exemplary computing system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the computing system 200 generally includes a personal computing device 210, a data store 220, a tagging engine 230, and a tag service 240. The personal computing device 210 may include any type of computing device, such as the computing device 100 described with reference to FIG. 1, for example. The tagging engine 230 may take the form of a dedicated device for performing the functions described below, may be integrated into, e.g., the personal computing device 210, a network access device, a search engine, or the like, or any combination thereof. The tag service 240 may take the form of a dedicated device for creation of tags, in which case such device may include any type of computing device (e.g., the computing device 100 described herein above), may be an Internet-based service, may be provided as a module inside a search engine, or any combination thereof. The components of the computing system 200 may communicate with each other via a network (not shown), which may include, without limitation, one or more local area networks (LANs) and/or wide area networks (WANs). Such networking environments are commonplace in offices, enterprise-wide computer networks, intranets and the Internet. It should be understood that any number of client devices, tagging engines, and tag services may be employed in the computing system 200 within the scope of embodiments of the present invention. Each may comprise a single device/interface or multiple devices/interfaces cooperating in a distributed environment. For instance, the tagging engine 230 may comprise multiple devices and/or modules arranged in a distributed environment that collectively provide the functionality of the tagging engine 230 described herein. Additionally, other components/modules not shown may also be included within the computing system 200.

In some embodiments, one or more of the illustrated components/modules may be implemented as stand-alone applications. In other embodiments, one or more of the illustrated components/modules may be implemented via the personal computing device 210, as an Internet-based service, or as a module inside a search engine. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of servers or client computing devices. By way of example only, the tagging engine 230 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

Generally, the computing system 200 illustrates an environment in which customized tags are generated to transfer data. As will be described in further detail below, embodiments of the present invention provide tags, including tag content, that are associated with a target item such that selection of the tag causes the tag content to be communicated to a computing device separate from the device that is displaying the tag.

The tagging engine 230 is configured to create customized tags for the transfer of data and associate the tags with a corresponding target item within a display device of a computing device such as, for example, the computing device 210. As previously stated, a tag, as used herein, refers generally to a digital image having tag content embedded therein. A target item, as used herein, refers generally to an item associated with a received user input. For example, a target item may be a search results page in response to a search query input, a particular search result within a search results page in response to a selection of the search result, and the like.

The tagging engine 230 includes a receiving component 231, an identifying component 232, a communicating component 233, and an integrating component 234. The receiving component 231 is configured to receive input from, for example, the computing device 210. The input may be a search query input, a web address input, selection of an item within a search results page, and the like. The input is associated with a target item. A target item, as used herein, refers generally to a destination location associated with an input. Target items may include, for example, a search results page associated with a search query input, a specific search result associated with a selection of the specific search result, a web page associated with a web address input, and the like. The receiving component 231 is further configured to receive customized tags from the tag service 240, as described in detail below.

The identifying component 232 is configured to identify tag content within a target item associated with the input received by the receiving component 231. Tag content may be determined by a content provider, a web service provider, or the like. In embodiments, tag content is identified as content that is desirable to transfer to a second computing device based on historical data. For example, a user's browsing session and subsequently executed actions may indicate that driving directions, for instance, would be useful if transferred to a second computing device.

In another embodiment, tag content is identified as content that is related to actions executed by a mobile phone. For example, common mobile phone actions may include placing telephone calls, sending short-message-service (SMS) text messages, accessing navigation tools, and the like. Accordingly, content that is identified as being related to mobile phone actions, such as telephone numbers (to make telephone calls) and addresses (for navigation) may be identified as tag content. While mobile phone actions are indicated herein as an exemplary tag content criterion, it should be understood that the present invention may be directed to any criteria desired for identifying tag content.

Tag content may be retrieved from a database, such as the data store 220, or may, alternatively, be generated once a user input is received and the target item is identified. Such real-time generation allows for the most up-to-date tag content to be used in tags since tag content may change periodically. For instance, a selection of a local restaurant from a search results page may prompt the identifying component 232 to identify tag content including, for example, a phone number for the local restaurant. Phone numbers change on a periodic basis for several reasons. Thus, by identifying the tag content once the input is received, use likelihood of the tag including up-to-date tag content may be increased.

The communicating component 233 is configured to communicate tag content to the tag service 240 for generation of a custom tag that includes the tag content. The tag service 240 receives the tag content from the tagging engine 230 and generates a custom tag that includes the tag content communicated by the communicating component 233. Once the custom tag is generated, the tag service 240 communicates the tag to the receiving component 231 of the tagging engine 230.

The integrating component 234 is configured to integrate the tag, received from the tag service 240, into a display with target item. For example, if a user has selected a search result within a search results page, the selection of the search result (i.e., the user input) is associated with a target item such (i.e., the destination location outputted upon selection of the search result). The integrating component 234 is configured to integrate the tag into the display of the target item such that the tag is presented in association with the target item. The communicating component 233 is further configured to communicate the target item with the integrated tag to the computing device 210 for presentation to a user.

The above-described example is relevant to generating a tag and presenting the tag on a first computing device (e.g., the computing device 210). Once presented by the first computing device, the tag is configured such that it may be selected by a second computing device. The second computing device may be any computing device capable of selecting a tag. In embodiments, the second computing device is a mobile phone.

The tag may be selected directly from the display device of the first computing device. The tag may be selected by the second computing device by, for example, scanning the tag. Upon selection thereof, the tag content that is embedded in the tag may be communicated to the second computing device. Thus, the actual content of the tag may be communicated to the second computing device.

In application, utilizing the exemplary system illustrated in FIG. 2, a user input is entered into the computing device 210. The user input is associated with, or indicates, a target item. Assume, for purposes of the present example, that the user input is a selection of a particular search result within a search results list. The user input is associated with a target item and, in this case, the target item is the destination location outputted upon selection of the particular search result (e.g., a web page associated with the search result).

The user input is communicated to the receiving component 231 of the tagging engine 230 via a network (not shown). Upon receiving the user input, the identifying component 232 then identifies tag content within the target item. The tag content may be identified according to any content preferences, established criteria, or the like of, for example, any tag administrator. In embodiments, the tag content is identified as content that is related to actions executed by a mobile phone.

Once the tag content is identified by the identifying component 232, the communicating component 233 communicates the tag content to the tag service 240. The tag service 240 generates a customized tag that includes the tag content and communicates the customized tag back to the receiving component 231 of the tagging engine 230.

Upon receiving the customized tag, the integrating component 234 integrates the customized tag into a display of the target item such that the target item is displayed in association with the tag. Continuing with the above example, if a user selected a specific search result from within a search results page, the integrating component 234 would integrate the tag into a display of the destination location outputted upon selection of the specific search result. The communicating component 233 then communicates the integrated tag, via a network (not shown), to the computing device 210 for presentation to a user. The user can then utilize a second computing device to select the tag directly from a display device of the computing device 210.

In other embodiments of the present invention, the tagging engine 230 is configured to integrate tags into search results. Thus, instead of associating tags with particular items within a search results page, as previously described, the entire search results page itself may be associated with a tag that allows a user, upon selection thereof, to access the search results page on a second computing device. Alternatively, the tagging engine 230 is configured to integrate tags into search results pages that are associated with a particular item within the search results page such that a user would not have to select the item in order to generate a tag for the item.

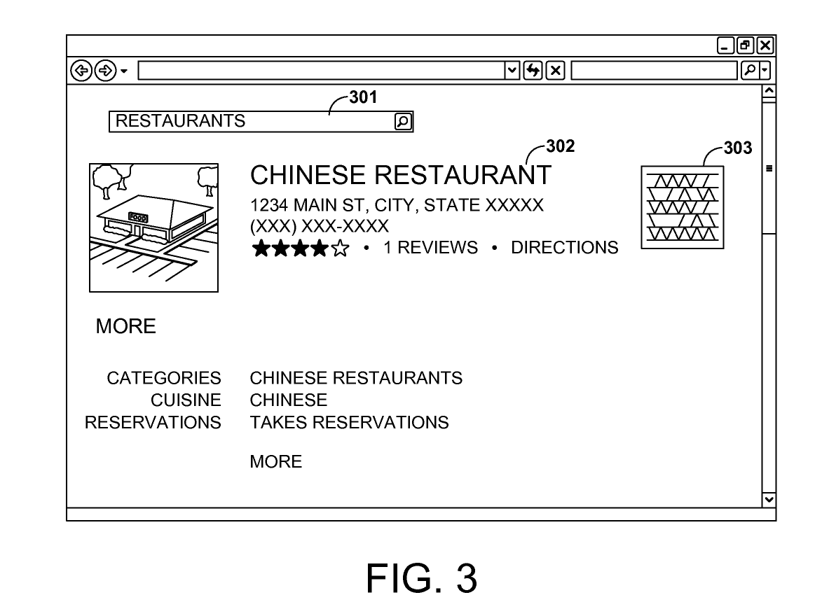

Turning now to FIG. 3, an exemplary graphical user interface (GUI) 300 is provided. A search query input area 301 is configured to receive a search query input from a user. In this example, a search query input for “restaurants” has been entered in the search query input area 301. As is customary, the search engine may return a list of search results. A user may then select a specific search result. GUI 300 illustrates an interface presented upon selection of a specific search result 302 for Chinese Restaurant. As illustrated in the GUI 300, search result 302 is associated with an address, a phone number, reviews, and directions. A tag 303 that has been generated for the search result 302 is indicated in GUI 300 and includes tag content associated with the search result 302. The tag content may include at least one of an entity identifier (i.e., Chinese Restaurant), the phone number, the address, directions, or the like. The tag 303 may be a standard tag, as illustrated in GUI 300 or may be customized by an entity. For example, should Chinese Restaurant choose to do so, it may customize a tag to associate with the search result 302 that is personalized to Chinese Restaurant. The personalized tag may graphically present, for example, a graphical entity identifier, a symbol associated with the entity, or the like.

A user may utilize a second computing device to select the tag 303 presented in the GUI 300. Once the tag 303 has been selected by the second computing device, the tag content associated with the search result 302 is communicated to the second computing device.

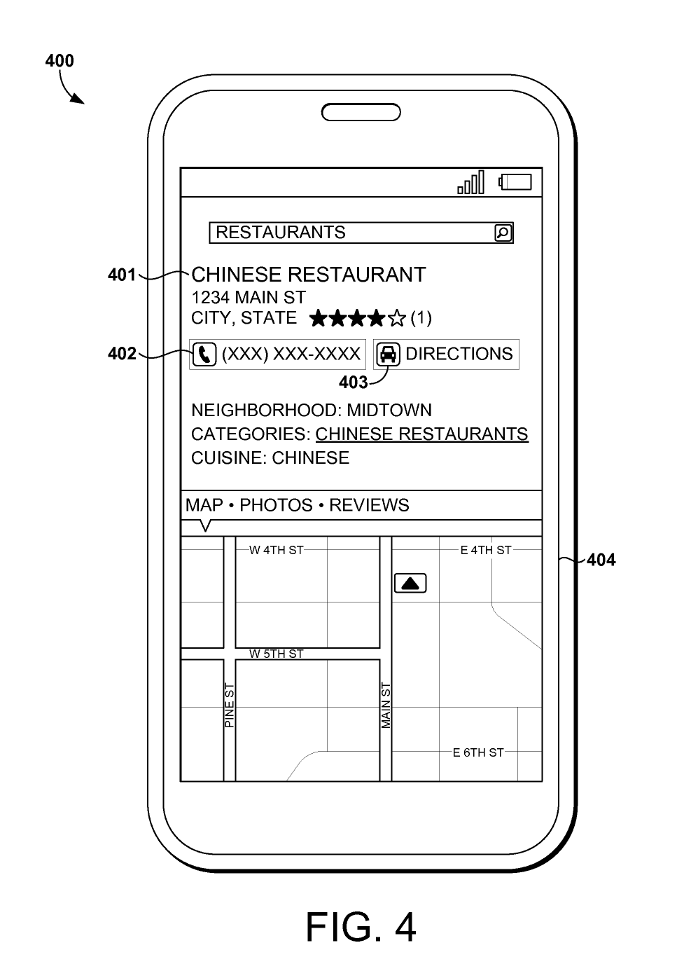

Once communicated to the second computing device, the tag content is displayed on the second computing device. FIG. 4 provides an exemplary GUI 400 for presenting tag content on a second computing device. The GUI 400 includes search result 401 and the associated address. Also indicated is a dial area 402 configured to allow a user to dial the phone number associated with the search result 401. A direction area 403 is also included and is configured to provide directions to the address associated with the search result 401. In embodiments, a map 404 may be provided upon selection of the direction area 403. Additional information included in the tag content may be presented in the GUI 400 of the second computing device.

In additional embodiments, tags may be generated and presented on a display device of a first computing device such that, upon selection thereof by a second computing device, the tag automatically causes the second computing device to execute an action. For example, a tag may be associated with a mobile phone application that a user discovered while browsing on the first computing device. Rather than the user being required to re-browse for the mobile phone application on their mobile phone, the user can select the tag from the first computing device with their mobile phone (i.e., the second computing device). The tag may be configured to perform as described above and communicate tag content to the mobile phone that would allow the user to download the mobile phone application (e.g., the tag content may include a selectable download button such that a user could select the button and download the application). Alternatively, the tag may be configured to, upon selection thereof, automatically execute a download of the mobile phone application on the mobile phone.

Additional capabilities of tags include, but are not limited to, downloading product specifications from online stores such that the product specifications are readily accessible on a mobile device while shopping offline, communicating search results to a second computing device such that a subsequent search is not required to achieve the same results, communicating a search history to a second computing device, communicating movie show-times and/or directions to a second computing device, and the like. This list is merely exemplary and is not intended to be exhaustive.

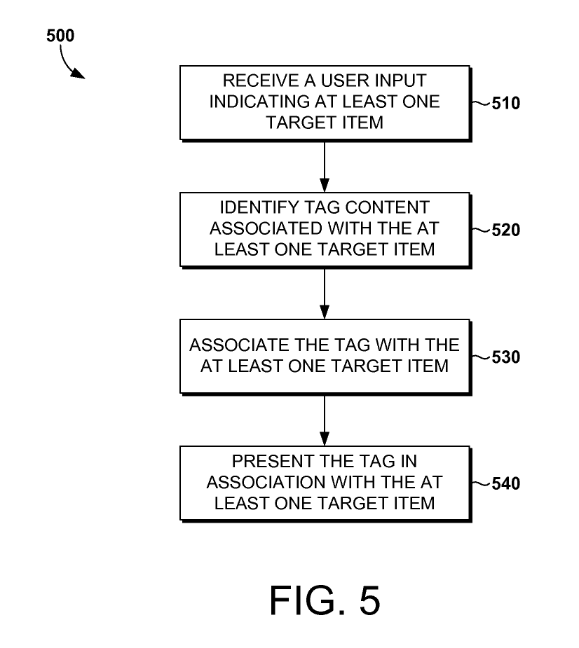

Turning now to FIG. 5, a flow diagram is provided that illustrates a method 500 for utilizing tags to transfer data, in accordance with an embodiment of the present invention. As indicated at block 510, a user input indicating at least one target item is received. At block 520, tag content associated with the at least one target item is identified. At block 530, the tag, including the tag content, is associated with the at least one target item. The tag is presented in association with the at least one target item at block 540.

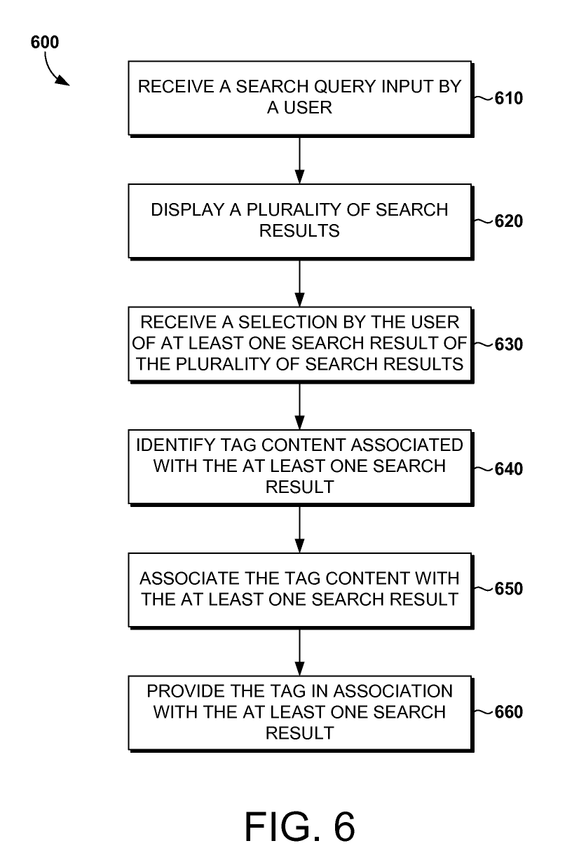

With reference to FIG. 6, a flow diagram is provided that illustrates a method 600 for utilizing tags to transfer data, in accordance with an embodiment of the present invention. As indicated at block 610, a search query input is received. Upon receiving the search query input, a plurality of search results is displayed at block 620. A selection of at least one search result is received at block 630 and tag content associated with the at least one search result is identified at block 640. The tag is associated with the at least one search result at block 650 and the tag is provided in association with the at least one search result at block 660.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 500 of FIG. 5 and the method 600 of FIG. 6 are not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method, the method comprising:
receiving, on a first computing device, a user input indicating at least one target item;
identifying tag content, associated with the at least one target item, to include in a tag, wherein the tag content is information identified as desirable to transfer to a second computing device;
associating the tag with the at least one target item such that the tag is displayed in association with the at least one target item; and
presenting the tag in association with the at least one target item such that selection of the tag by the second computing device triggers the tag content to be communicated to the second computing device.

2. The one or more computer-readable storage media of claim 1, wherein the user input is a search query input or a selection of at least one search result.

3. The one or more computer-readable storage media of claim 1, wherein the second computing device is a mobile phone.

4. The one or more computer-readable storage media of claim 3, wherein the mobile phone utilizes the tag content to perform mobile phone actions including at least one of communicating a telephone call, mobile messaging, and navigating to a destination.

5. The one or more computer-storage media of claim 1, wherein the second computing device selects the tag by scanning the tag from a display device of the first computing device providing the tag.

6. The one or more computer-storage media of claim 1, wherein the method further comprises storing the tag in association with the at least one target item.

7. The one or more computer-storage media of claim 1, wherein the information identified as desirable to transfer to a second computing device is based on historical data.

8. The one or more computer-storage media of claim 7, wherein the historical data includes data indicating actions executed by a mobile phone.

9. A system for generating customized tags, the system comprising:
a computing device associated with one or more processors and one more computer-readable storage media;
a data store coupled with the computing device; and
a tagging engine that receives an indication of a target item, identifies tag content associated with the target item, and presents the tag in association with the target item on a display device of the computing device.

10. The system of claim 9, further comprising a second computing device that selects the tag from the display device of the computing device.

11. The system of claim 10, wherein the second computing device is a mobile phone.

12. The system of claim 10, wherein the tagging engine configures the tag such that it is communicated to the second computing device upon selection thereof by the second computing device.

13. The system of claim 10, wherein the second computing device is configured to select the tag from the display device by scanning the tag.

14. The system of claim 9, wherein the tagging engine identifies tag content based on historical data indicating actions executed by a mobile phone.

15. The system of claim 9, wherein the tagging engine identifies the indication of a target item as a search query input.

16. One or more computer-readable storage media storing computer-useable instructions that, when used by one or more computing devices, cause the one or more computing devices to perform a method, the method comprising:
receiving a search query input by a user at a computing device;
in response to receiving the search query input, displaying a plurality of search results;
receiving a user selection of at least one search result of the plurality of search results;
identifying tag content, associated with the at least one search result, to include in a tag;
associating the tag with the at least one search result such that the tag is configured for selection by a mobile phone, wherein selection of the tag by the mobile phone triggers the tag to be communicated to the mobile device; and
providing the tag on a display device of the computing device in association with the at least one search result.

17. The one or more computer-storage media of claim 16, wherein the mobile phone selects the tag by scanning the tag from the display device of the computing device.

18. The one or more computer-storage media of claim 16, wherein the tag content to include in the tag includes content related to actions executed by the mobile device.

19. The one or more computer-storage media of claim 18, wherein the actions executed by the mobile device are at least one of placing a call and navigating to a place of interest.

20. The one or more computer-storage media of claim 16, further comprising providing a second tag associated with a page displaying the plurality of search results and presenting the tag on the display device in association with the page displaying the plurality of search results such that selection thereof by the mobile phone communicates the search results to the mobile phone.
